(19) United States
(12) Patent Application Publication
(10) Pub. No.: US 2019/0026806 A1
(43) Pub. Date: Jan. 24, 2019

(54) System and method of responding to consumer demand to facilitate exchange of goods or services

(71) Applicants: Yuliya Kozina, TAMPA, FL (US); Vladimir V. Kozin, DURHAM, NC (US)

(72) Inventors: Yuliya Kozina, TAMPA, FL (US); Vladimir V. Kozin, DURHAM, NC (US)

(21) Appl. No.: 15/903,026

(22) Filed: Feb. 22, 2018

Related U.S. Application Data
(60) Provisional application No. 62/462,511, filed on Feb. 23, 2017.

(51) Int. Cl. G06Q 30/06

(52) U.S. Cl. CPC G06Q 30/0619; G06Q 30/0627; G06Q 30/0605; G06Q 30/0611

(57) ABSTRACT

A system and method of collecting, analyzing and prioritizing responses from suppliers to satisfy consumer demand for goods or services. The method comprises receiving information about consumer demand for an item or service, collecting a plurality of responses to the consumer's request, and calculating the priority score value of each of the responses based on the user rating of the author of the response and the content score of the response by applying algorithmic and heuristic rules. Further, the consolidated responses are presented to the consumer in an order prioritized by their score value to satisfy the demand for the item or service.

### BACKGROUND OF THE INVENTION

Most of the conventional informational and electronic resources designed for exchanging goods or services (online stores, online auctions, service directories, shopping applications) address needs of service providers or suppliers of goods. They are designed in such a way that the transaction is initiated by the supplier who first publishes information about their goods or services. Potential customers spend time and efforts searching or browsing through multiple advertisements of products and services before they can order goods or services.

Moreover, most of the conventional online resources provide limited or inadequate search capabilities and prioritize search results in the interest of suppliers, not the consumer. Other powerful and capable online search engines return results according to their proprietary formulas, which give advantage to paid advertisements or rank advertisement articles based on the authority or popularity of the supplier rather than the interest of the consumer. Consequently, the consumer is served with articles about unrelated products or services and actively bombarded with annoying advertisements.

As a result, an individual looking for an exact item or service gets overwhelmed by a huge waterfall of information containing vast variety of responses, of which very few relate to what the consumer needs, and those that do relate are buried deep under the pile of irrelevant articles and advertisements from powerful organizations and capable individuals.

### FIELD OF THE INVENTION

Methods and systems consistent with the present invention utilize a data processing system to consolidate and prioritize information received from suppliers to satisfy consumer demand for an item or service.

### SUMMARY OF THE INVENTION

The present invention overcomes the shortcomings of existing systems by directly addressing demand of an individual consumer for a certain item or service. In the implementation consistent with the present invention a data processing system allows an individual to post a request for a particular item or service and illustrate it with text, pictures, or photos; it allows other individuals to post responses to the original request for the item or service and illustrate their responses with text, pictures, or photos. In the implementation consistent with the present invention in order to satisfy consumer demand, a data processing system analyzes and evaluates each submitted response, calculates its response priority score, and uses it to prioritize the response. Total response priority score value is dependent on the feedback score of the user who posted the response as well as the content score of the response.

In the implementation consistent with the present invention a data processing system prioritizes the plurality of submitted responses based on their priority score before presenting them to the individual who posted the request for the item or service. Responses having the highest total priority score are considered highly relevant and given the most importance in the display order. Responses with lower total priority score are assigned lower importance before being displayed. The responses are presented to the consumer without disclosing private information of the associated users.

The individual consumer who posted the original item or service request is presented with a list of responses sorted by relevancy and given an opportunity to pick the satisfactory response. After picking one or more of the satisfactory responses the responder's and the poster's contact information is revealed to the parties engaged in the purchase or exchange transaction. After obtaining each other's contact information the parties will be able to complete the transaction.

Upon completing the transaction, both parties assess the other party and the transaction outcome. The assessment feedback affects the user score of both the original poster and the selected responder. For example, a positive assessment feedback from both parties improves the user score of both parties. As mentioned earlier, the user score also affects the priority of the future responses posted by the user. Specifically, the user score is an important weighting factor during determination of his or her priority of responses; in most cases it has higher weight than the score of the response content. Consequently, the higher the score of the user, the higher the total priority score of their responses is. Responders or suppliers with lower user scores have their responses assigned lower priority even if the content of the response itself has high content score.

### BRIEF DESCRIPTION OF THE DRAWINGS

FIG. 1 illustrates a sample layout of network architecture, in accordance with one embodiment.

FIG. 2 shows a flowchart depicting operations of one embodiment of the invention.

FIG. 3 illustrates a response priority trend dependent on positive user score, in accordance with one embodiment.

FIG. 4 illustrates response priority trends dependent on negative user score, in accordance with one embodiment.

FIG. 5 illustrates an exemplary workflow, in accordance with one embodiment.

FIG. 6 illustrates a sample layout of an online page depicting a demand post along with the related responses, in accordance with one embodiment.

FIG. 7 illustrates a sample layout of an online form for entering a response to a demand post, in accordance with one embodiment.

### DETAILED DESCRIPTION OF THE INVENTION

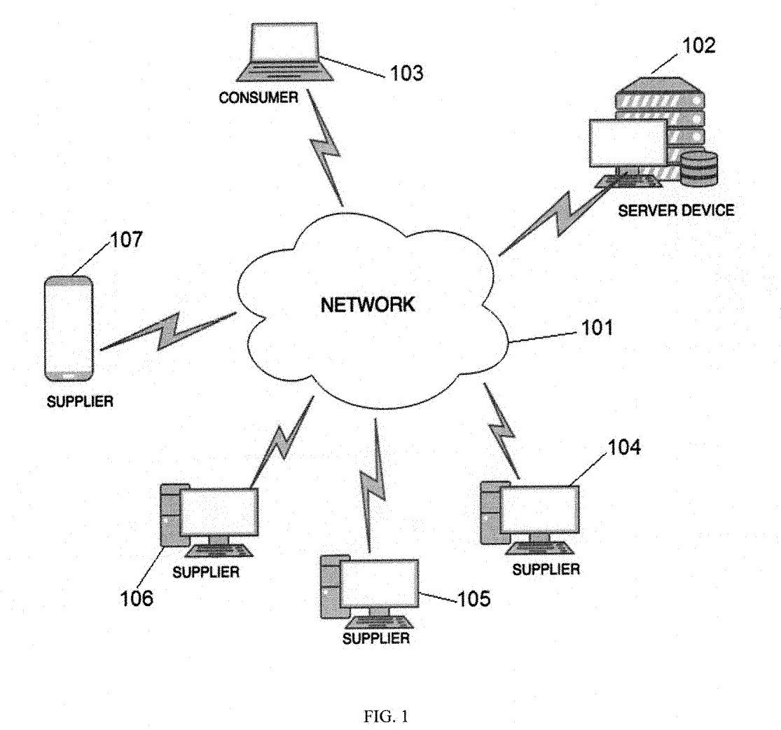

FIG. 1 illustrates a network architecture, in accordance with one embodiment. As shown, a network 101 is provided. In the context of the present network architecture, the network 101 may take a form or a combination of networks including, but not limited to a wide area network (WAN) such as Internet, a local area network (LAN), a wireless or telecommunications network.

Connected to the network 101 is a plurality of devices. For example, a server device 102 and a user computer device 103 are connected to the network 101 for communication purposes. The user's computer device may be a portable computer 103, a desktop computer 104, a smartphone or a personal digital assistant (PDA) 107, etc. The server device 102 may be implemented, for example, using hosting services or cloud.

In an embodiment consistent with the present invention, the server device 102 is equipped with data processing hardware such as a processor (CPU), memory, network hardware, and data storage. The user devices 103, 104, 105, 106, and 107 are equipped with data processing and input and output hardware including, but not limited to keyboard, screen, touchpad, mouse, as well as processor (CPU), memory, and network communication hardware. It should be noted that any of the computer devices in the present network architecture, as well as any other unillustrated network devices, are equipped with network communication software. Specifically, the server 102 is equipped with network broadcasting software such as web server; the user devices 103,104,105,106 and 107 are equipped with network client software such as web browser,

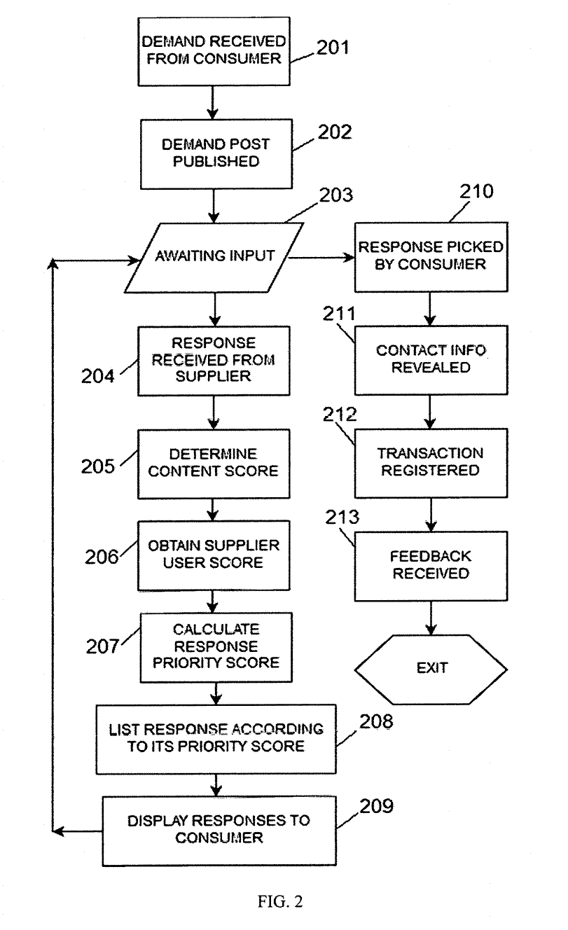

FIG. 2 shows a flowchart illustrating one embodiment of the invention. It comprises data input as well as data output operations conducted on the server device. A typical implementation relates to the context of the architecture shown on FIG. 1, or other network environment.

As shown in operation 201, the system receives input from a consumer regarding demand for an item or service. The input is received in the electronic form, such as via a website, via a mobile application, or via other electronic message. The information may include a description of the desired item or service, a category of the desired item or service, pictures or photos to illustrate the item or service, a type of demand for the desired item or service, including, but not limited to: purchase request, exchange request, repair request, or help request. The information may also include a description of a monetary or non-monetary reward for satisfying the demand for the item or service. The information submitted by the consumer is registered and stored on the server device.

In operation 202, the demand input is processed by the server device and published electronically on the network, for example in the form of a webpage, to allow other users to see the information about the requested item or service. The information may be published to be seen by all or limited number of other users of the system. For example, the information may be published to only a group of users who identified themselves as interested in certain categories of goods or services.

The system then awaits for the input from users of the system, as illustrated in operation 203. The input is received from individuals who have information relevant to the consumer demand. Those individuals may know how to obtain the desired item or service, or be potential suppliers who may have the desired item or service. The inputted information may include details about the item or service, availability of the item or service, pictures or photos for further illustration. The input may also contain other information related to the requested item or service. In operation 204, such input is received from a supplier in the form of a response to the demand for the item or service. The response is received in the electronic form, such as via a website, electronic message, or a mobile application. The response and the submitted information are recorded in a database.

In the implementation consistent with the present invention, the submitted response information is further analyzed in operation 205. A response determined to be an exact match to the requested item or service receives the highest calculated content score value. Responses containing substitute products or services, or those describing a similar, equivalent or alternative item or service, are assigned lower content score. Responses with recommendations, or sales leads, or descriptions of methods of obtaining the requested item or service would be assigned even lower content score. In the preferred embodiment, the content score of the response cs(R) is a value in the interval [1, 10] where value of 10 indicates the exact content match and 1 is the minimum useful information such as pure advertisement. In another embodiment, the content score may have a value outside of the above interval, or omitted completely.

The user score of the user who submitted the response is obtained in operation 206. In a preferred embodiment, the score of a user is proportional to the number of exchange transactions the user has participated in and accounted in points where each point may be equal to one committed and positive exchange transaction. In another embodiment, the score of the user may take into account another type of user feedback such as number of submitted responses accepted by other users. In the operation 206 the user score is obtained from a database controlled by the server device. In other embodiments of the present invention, the user score may be obtained from a distributed database such as cloud network storage.

In operation 207, the priority score of a user response P(R) is further calculated based on the supplier user score determined in operation 206 and the content score determined in operation 205.

According to the present invention, the priority of a user response P(R) is proportional to the positive score of the user ps(U) measured in points and reverse proportional to the negative score of the user ns(U) measured in points, further adjusted by the content score cs(R) of the response. It is affected by feedback probability factors and adjusted to avoid division by zero. In the preferred embodiment, the Priority of a response is calculated as:

P(R)=(A+ps(U))*X/((1+ns(U))*Y)+cs(R)

Where A is a heuristic constant of initial positive points given to all users. It's value must be greater than zero, preferably A>1 to outweigh negatives, e.g. A=2, as 1 is assumed as the minimum number of negative feedback points in the denominator to prevent division by zero.
X and Y are heuristic probability constants in the interval [0, 1], such as:
X is the probability factor of 0.50, which corresponds to a 50% probability of getting a valid positive feedback, Y is the probability factor of 0.75 (75% probability of getting a valid negative feedback). By more heavily weighing the negative feedback, the goal is to discourage users from evoking such feedback and encourage more positive interactions.

Consequently:

for response content score−10 (exact match) and user score=0 (both ps(U)=0 and ns(U)=0), the priority score of the response would be calculated as (2+0)*0.5/((1+0)*0.75))+10: P(R)=11.333(3)
for response content score=10 and user positive score of 10 (ps(U)=10), and with zero negative feedbacks of the user (ns(U)=0), the priority score of the response will be 18: P(R)=6/0.75+10=18

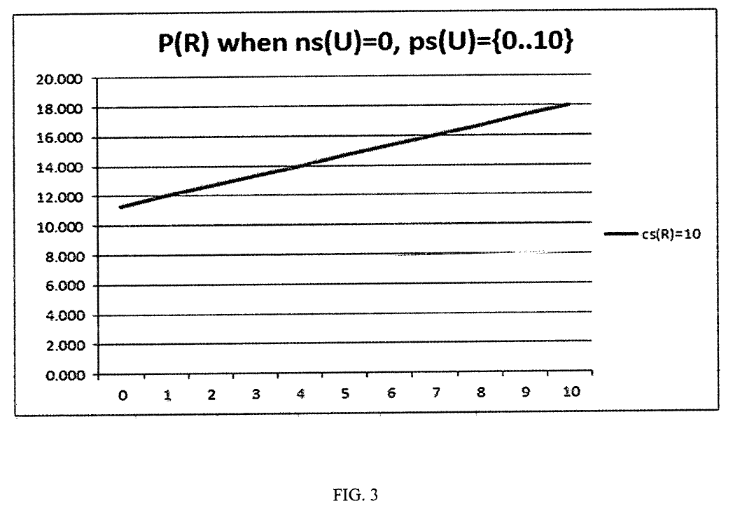

In other words, the priority score of the response submitted by a user with even a small positive user score is higher than from a user with no user score at all. FIG. 3 illustrates a trend where a user's response priority score grows relative to the positive user score with the highest content score of 10 out of 10 and no negative user score. Initial positive point value A assumed equal to 2.

Alternatively:

if response content score is 10 out of 10 and positive user score consists of 10 positive points (ps(U)=10), but the negative user score is 7 points (ns(U)=7), the priority score of the response will be 11: P(R)=6/(8*0.75)+10 =11

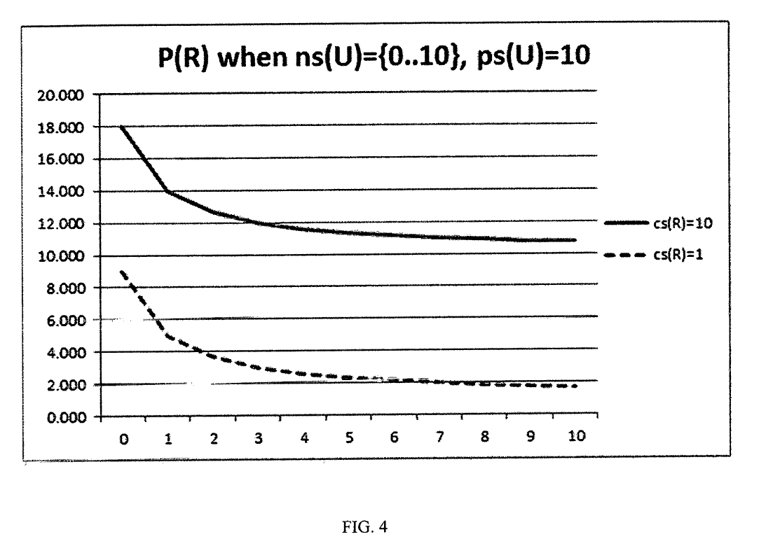

In other words, under the same conditions, a post from the responder with more than 50% of negative feedbacks will have lower priority score than a post from a new user with no feedback score at all. FIG. 4 illustrates how fast the priority score of response will fall depending on user's negative feedback score, given the content score is 10 out of 10, juxtaposed against the low content score of 1 out of 10. Initial positive point value A assumed equal to 2.

According to the present invention, users having zero negative score points are given advantage over users having negative points by awarding them with relatively high priority score of their posts even if they post mediocre responses having content score of 5 out of 10. Assuming the user's positive score of 10 points (ps(U)=10) with zero negatives (ns(U)=0) and the content score of 5 out of 10 (cs(R)=5), the priority score of their response will be 13: P(R)=5+6/0.75=13.

Consistent with the present invention, there are several ways to adapt it to various situations. Firstly and primarily, the responses to the consumer demand are prioritized in the interest of the consumer, not only the supplier. Secondly, the responding suppliers are strongly incentivized to receive strictly positive feedback and to avoid even a single negative feedback. They are objectively discouraged from getting any negative feedback. Further, the heuristic values of probability constants X and Y can be further adjusted to accommodate weight of the negative user feedback score versus the positive user feedback score.

In its preferred embodiment for the purpose of better addressing consumer demand the present invention takes advantage of the higher probability factor of a negative feedback thus assigning higher weight to the negative user score of a prospective supplier rather than simply subtracting the negative score points from the positive score points or total score points of the user.

In another embodiment, the response content score may be omitted from the calculations, therefore the response priority score is determined only based on the user score of the author of the response.

Real usage data, when available, can be used to adjust the heuristic X and Y factors. In another embodiment of the invention, the content score can also be adjusted based on the geographic area or demographics. Furthermore, in another embodiment of the invention, the value of A can be further adjusted to also account committed product or service transactions still awaiting feedback.

Over time, the described system will fill gaps in the usage data and provide a more accurate and comprehensive computational and data model.

Various implementations of the invention have the advantage that the formula is very simple and computationally fast. For example, priority scores of responses to a certain consumer request can be recalculated on-the-fly and re-prioritized as soon as the user scores of the respective responders change. In another embodiment, for specific users or demand posts the corresponding responses may be re-prioritized and the priority scores recalculated if the consumer changes their content preferences thus changing the content scores of submitted responses.

Consistent with the present invention, as shown in operation 208, the plurality of responses is prioritized according to the collected information and calculated values. In the preferred embodiment the responses may be physically arranged in the database storage according to their calculated priority scores to facilitate the highest performance of the system output. In another embodiment the responses may be indexed in the database storage according to their priority scores.

As illustrated in operation 209, the list of responses is then displayed to the individual who posted the request for the item or service. Responses having the highest total priority score will be considered highly relevant and given the top priority in the display order. Responses with lower total priority score are assigned lower priority before being displayed. The responses are presented to the consumer without disclosing private information of users associated with the posts.

In the preferred embodiment, the responses may be ordered to present the responses with higher priority values first and low priority values last. If needed, the responses can be grouped by additional criteria such as posting date or geographic area. In another embodiment, responses with higher priority scores may be highlighted with a different color or font size or emphasized otherwise to be given more visual weight.

The consumer who posted the original item or service request is given an opportunity to pick the satisfactory response from the variety of responses. The system receives the input from the consumer in operation 203. The consumer may pick one or more of the satisfactory responses which is recorded in operation 210. In the preferred embodiment, the recorded event of selecting a response in the operation 203 increments the positive user score of the author of the selected response.

In operation 211, certain responder's and the poster's contact or personal information is revealed to each other as parties involved in the commodity or service exchange transaction, according to each user's privacy agreement. After obtaining each other's contact information the parties should be able to complete the transaction. In one embodiment, the transaction may be marked as completed and further input from other users regarding this transaction is blocked. The parties involved in the transaction are allowed to provide limited input such as an option to assess the other party as well as the transaction outcome.

The assessment feedback affects the user scores of both the consumer and the selected responder. For example, a positive assessment feedback from both parties improves the user scores of both parties. As mentioned earlier, the user score affects the priority of the future responses posted by the user as the user score has more weight than the content score in calculating total priority score. The higher the user score of the responder, the higher will be the calculated priority score of their responses. Responders or suppliers with lower user scores have their responses assigned lower priority even if the content of the response is assigned higher content score.

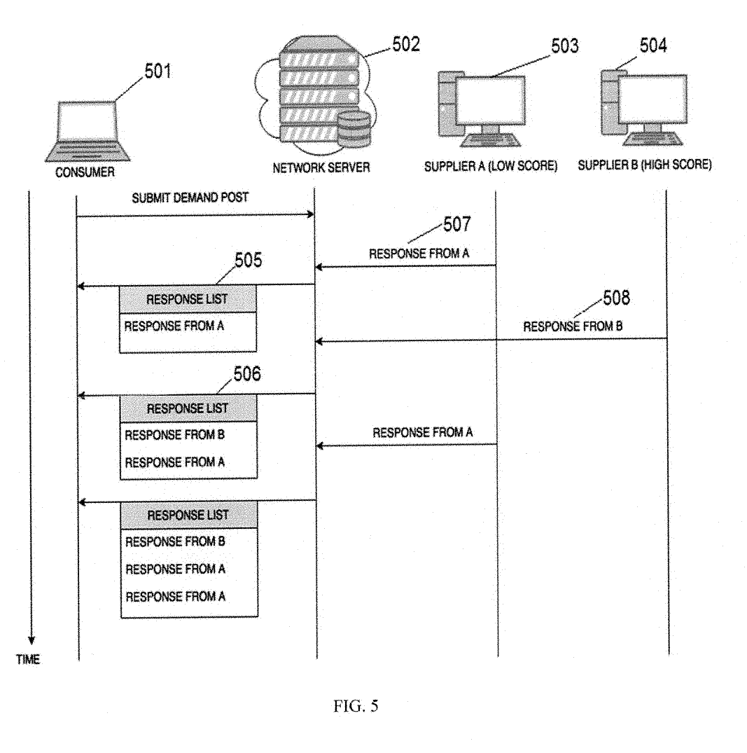

As shown on FIG. 5, and according to the present invention, the communication between the consumer and potential suppliers or providers of products or services is done via the server 502 and via common network to which all participating computers are connected. In an alternative embodiment, the server 502 may be replaced by a network cloud comprising multiple interconnected servers.

According to the preferred embodiment, and, a response from a supplier 504 having higher user score has higher priority than any response from a supplier 503 with lower user score. According to the present invention, this stays true even if the supplier 503 had posted their response earlier in time than the supplier 504.

In the embodiment illustrated by event timeline on FIG. 5, the consumer 501 who posted a demand for an item or service will not see any responses until at least one supplier posts a response 507. Once a supplier 503 posts the first response 507, the consumer 501 sees the list of responses 505 containing all available responses at that point in time.

Once a different supplier 504 submits their response 508 to the demand post, the consumer 501 sees the updated list of responses 506 as soon as the consumer 501 connects to the server 502 to obtain the most recent list of responses. The response list is prioritized according to the present invention as soon as a relevant response is added, but before being displayed to the consumer.

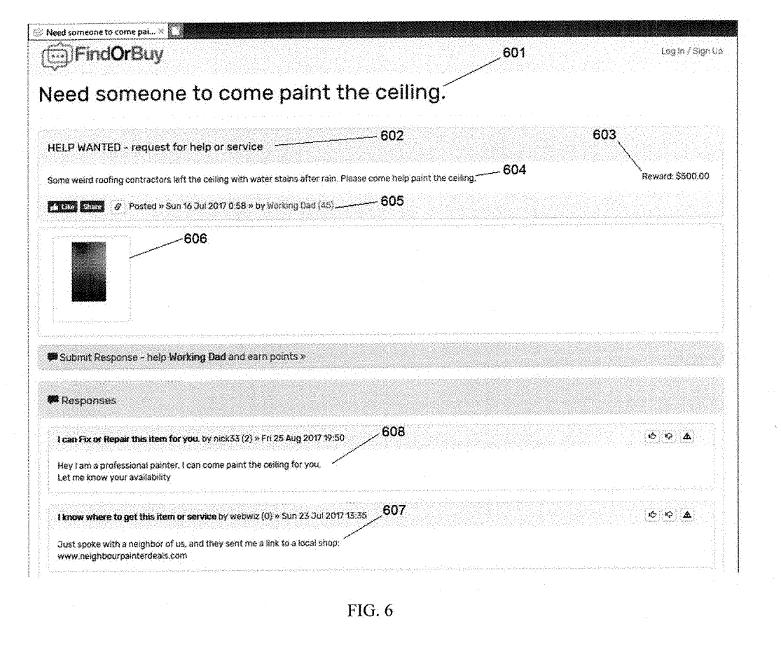

FIG. 6 illustrates an exemplary online page displaying the demand post information submitted by a consumer 605, along with related responses 607 and 608 submitted by suppliers of products or services. In the preferred embodiment, the consumer 605 submits the demand post titled as 601 along with the full description of the demand 604. The consumer must set the request type 602 as part of their input. The post may state the reward amount 603 offered by the consumer 605 for the requested product or service as well as illustrations in the form of photos 606, drawings, or other graphical information.

According to the present invention, all responses are prioritized according to the content score of the response and the user score of the author of the response before being displayed. FIG. 6 illustrates that the response 608 is displayed on the top of the list as having higher calculated priority score than the response 607 despite the response 607 having earlier post timestamp.

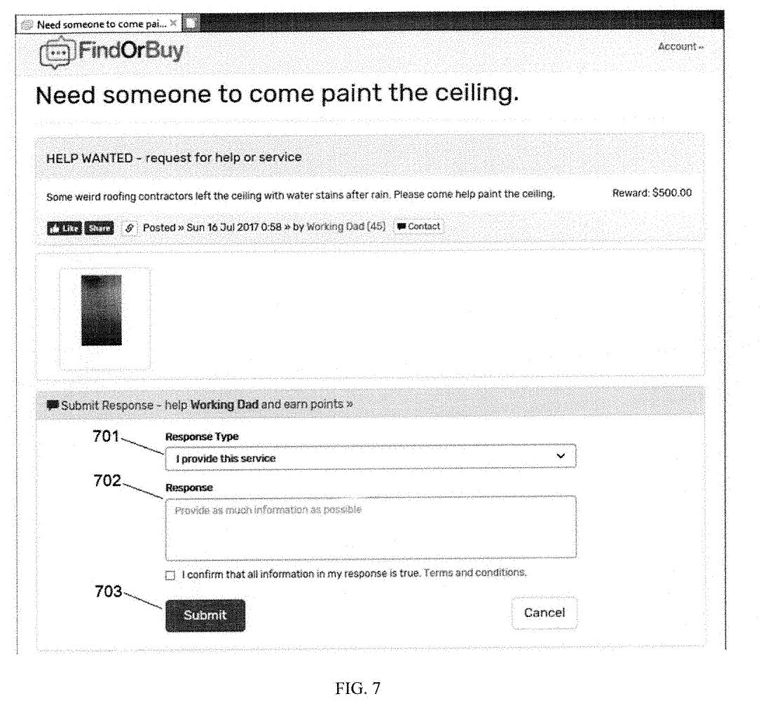

FIG. 7 illustrates the exemplary embodiment of the process of submitting a response to the demand post. The provider of a product or service must select the type of the response 701 and enter the detailed description 702 of the particular solution to the customer's problem. Once the response is submitted, it will be stored in the database and further analyzed based on the initial content score and the user score of the author.

In the preferred embodiment, all activity of all users within the system is recorded in the database. Each demand post increments the positive user score of the respective consumer. Each provider's response selected as a solution to the consumer's demand post increments the positive user score of the author of the selected response. Each assessment of the transaction outcome between the consumer and provider affects the user score of each participant of the transaction.

As other users of the system browse submitted responses they voluntarily or inadvertently affect the content scores of those responses. In one of the embodiments, other users of the system may up-vote or down-vote responses, or provide other voluntary feedback such as to mark the responses as spam or toxic or otherwise requiring attention of the system administrator. The votes are recorded in the database. The number of votes per user per response is limited. In another embodiment, the system may record click to zoom events or expand details events initiated by users, thus determining the most popular responses, and adjust the content score of the most viewed or most popular responses accordingly.

As a method to attract or incentivize users to submit their responses to a consumer's demand post an option of rewarding the winning responder may be implemented. In the preferred embodiment, the consumer enters the monetary amount they are willing to pay for the solution to their problem as part of the original demand post. The entered monetary amount is made visible to other users of the system who may decide to answer to the demand post with their response about a product or service. In one embodiment, the reward amount may stay editable by the consumer until the transaction is committed. In an alternative embodiment, it may be made read-only after the first response is submitted to the consumer's demand post to prevent fraudulent postings and further attract responders. After the satisfactory response is selected from the multitude of responses and the transaction is completed, the consumer is assessed and their user score is further adjusted also based on their ability to pay the reward to the selected responder.

One possible method of monetization of the present invention may be by implementing a selective pay per post system. An example of that is if the customer is charged a small fee for submitting their demand post. The fee is adjusted based on the amount of the incentive reward submitted as part of the demand for a product or service.

Another method of monetization may be a pay per view (PPV) system. An example of that method is charging advertisers a small fee for displaying an advertising link, text, or banner within the regions and the context of the page with the demand for a product or service.

Another method of monetization may be a subscription-based fee charged to users for unlocking certain tools to improve efficiency of their activity or enhance user experience. An example of that method is if the provider of goods or services is charged a small fee for displaying their information in alternate color to enhance visibility of their response.

Another method of monetizing the service may be to provide paid access to the data via application programming interfaces (API). An example of that method is if a 3^{rd} party company is developing a mobile application to facilitate better user experience with the system and is charged a one-time fee or a subscription fee to access the data.

One more method of monetizing the present invention may be by brokering monetary transactions between users of the system, specifically, between consumers and suppliers by withholding a percentage point from the declared reward amount.

While the method of prioritizing the responses to demand described in the present invention may not cover all possible situations, the advantages of the present invention include, without limitation, its ability to better address the objectives of a consumer during an item or service exchange transaction. The present invention determines the relevance of responses in a way to help satisfy the demand in the best interest of the consumer.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### Example #1

An example of the method may be illustrated with an example of a consumer searching for an automotive part to replace a worn-out or a broken part. The consumer is interested in obtaining the exact part made by the particular car brand (OEM), or an identical part made by another reputable manufacturer. The consumer describes the item, includes the part number and the manufacturer, and possibly posts a photo of the original part.

An OEM part supplier who has the particular part in stock may submit a response to the consumer's request. That type of response is classified as an “exact match” and gets the highest initial content score of 10 points.

An individual who doesn't have the part, but who knows where the customer can obtain the exact or a compatible part may also respond to the consumer's request. Their response would be a relevant and helpful advice however is not an exact match; therefore it is assigned the initial content score of 5 points.

An advertiser may also submit a response containing advertising information about an aftermarket part store. Their response is given a lower but positive score of 1 point because it is not directly relevant to the exact part mentioned in the original post.

The initial content score value is assigned based on the initial response type picked by each responder as part of their response from one of the options: “I have the exact item”, “I know where to get the item”, or “Useful or other information”. This is just one example of responses; there may be more or less options and they could vary depending on the implementation. The responders must include the response type when they submit their response.

Visitors who see the original post as well as the submitted responses may assess the response value and judge how well the content of the response matches the claimed response type. They have an option of up-voting or down-voting each response, or even flag the response as ‘spam’ or ‘toxic’, which may trigger an action from the system administrator. Each visitor is only allowed one optional vote on each response. The votes are stored in the database, and their sum value is accounted. They may affect the content score of the corresponding response depending on implementation. Responses with too many negative votes are hidden from the view; they drive the user ratings of their authors down, and in certain cases may even cause their authors to be banned from using the system.

After calculating the priority scores of all responses, the responses with the highest priority scores are displayed next to the customer's request post. Responses with lower priority scores are displayed further away, or on the next page, or even several pages down the list. Responses confirmed as having toxic or spam content are not displayed at all.

As the consumer's post stays active for a while, more visitors will come and respond to the original post. After a while the consumer decides to pick the best response to their request. The accepted response will add positive user score points to the author of the selected response. All other users who submitted relevant responses may also get some positive points to their user score as a participation reward, to encourage community involvement. Toxic or irrelevant responses will not bring any positive user score points to their authors.

As the database gets populated with data over time, users who collected the most positive user score points will have more authority when submitting their responses. That will prioritize their responses higher among submitted responses therefore giving them higher probability of being picked by the consumer.

### Example #2

Another example of the method may be illustrated with an example of a homeowner consumer looking for someone to help them paint the ceiling. The particular workflow may be further illustrated by the FIG. 6 and FIG. 7. The consumer 605 knows exactly what they need (601) and describes the exact problem 604 which they further illustrate with the photo 606. To attract more responses, they may even include the reward amount 603 they are willing to pay for the requested service 602.

If there are service providers willing to help the consumer, they will post their responses relative to the original post. If the reward amount is too low, there may be no responses at all.

If there are no responses as there are no service providers willing to take the job, the original poster may increase the reward, or even remove it completely and adjust the problem description to better incentivize service providers. This may attract more service providers, therefore more responses will appear in relation to the original demand post.

When the consumer decides to pick a certain service provider, they select the winning response. After that, the consumer and the provider will exchange certain contact information to facilitate the job transaction.

Upon completing the job, both the consumer and the service provider have the option to assess the opposite party performance in the transaction. If the service provider did not receive the reward originally stated in the demand post, they may decide to post negative feedback at the consumer. The feedback will be recorded in the database and reflected in the consumer's user score.

If the consumer has other active demand posts that are still active in the system, his or her rating will be immediately updated with the newly submitted transaction rating outcome and become visible to responders.

What is claimed is:

1. A method to better address consumer demand for an item or service through a calculation to prioritize suggested items or services with the highest response priority score, comprising:
establishing a user account for a consumer wherein the profile information about the consumer is stored in a database;
establishing a user account for a provider of products or services or an individual having information about products or services wherein the profile information about the provider or the individual is stored in a database;
receiving a request from the consumer for a product or service;
publishing the consumer's request for the product or service online to all users of the system in the form of a demand post wherein the post may contain text and graphics;
receiving the plurality of responses to the consumer's request from multitude of product suppliers, service providers, or individuals with information about product or service provision wherein the responses may contain text and graphics;
presenting the submitted responses to the consumer according to the calculated priority score, wherein personal information about the responders is kept anonymous to encourage objectivity;
assisting the commodity or service exchange between the consumer and the provider by facilitating the consumer's selection of the satisfactory response;
providing further information exchange between the consumer and the product or service provider based on their privacy agreement;
calculating a user feedback score based on historical interactions between a consumer and a supplier or individual and their feedback of each other, wherein negative feedback is weighted more heavily to incentivize positive interactions.

2. The method of claim 1, wherein the consumers and product or service providers are connected to the common server via a communication network of computers and mobile devices.

3. The method of claim 1, wherein the data entered by the consumer as well as the data entered by product or service providers is received in an electronic form via a network of electronic devices.

4. The method of claim 1, wherein each response submitted by providers of products or services is analyzed to calculate the content score in relation to the consumer request for a product or service.

5. The method of claim 4, wherein each submitted response is assigned a priority score calculated by means of a computational algorithm.

6. The method of claim 5, wherein both the user score of the author of the response and the content score of the response are used as input parameters for the response priority score computational algorithm.

7. The method of claim 1, wherein the responses submitted by providers of goods or services are displayed online in relation to the consumer's original post and presented favoring the highest calculated priority score.

8. The method of claim 1, wherein the actions of users during browsing and selection of the satisfactory response are recorded in the database.

9. The method of claim 1, where the actions of users after committing the commodity exchange transaction are recorded in the database.

10. The method of claims 4 and 8 wherein the priority scores of submitted responses are recalculated accordingly as the content scores change to reflect new and updated information.

11. The method of claims 5 and 9 wherein the priority scores of responses are recalculated accordingly as user scores of participants are updated in simultaneous transactions.

12. The method of claims 5 and 8 wherein the priority scores of submitted responses are recalculated accordingly as users provide feedback on these responses.
